(19) United States
(12) Patent Application Publication
(10) Pub. No.: US 2023/0041871 A1
(43) Pub. Date: Feb. 9, 2023

(54) PLUMBING ROUTING SYSTEM AND METHOD

(71) Applicant: Paul Jahn, Calgary (CA)

(72) Inventor: Paul Jahn, Calgary (CA)

(21) Appl. No.: 17/817,395

(22) Filed: Aug. 4, 2022

Related U.S. Application Data
(60) Provisional application No. 63/229,147, filed on Aug. 4, 2021.

(51) Int. Cl. F16L 3/22; G01M 3/18; G01M 3/16; F16L 3/02

(52) U.S. Cl. CPC F16L 3/221; G01M 3/18; G01M 3/165; F16L 3/02

(57) ABSTRACT

Systems and methods for routing a plumbing line along a wall include tracks having clip-retaining mechanisms and being attachable to the wall; plumbing-retaining members for gripping the plumbing line and being removably anchored to the clip-retaining mechanisms; and covers removably securable to the tracks. The systems and methods can further include a leak detection system comprising strips of conductive material on the tracks, the covers, or both. The strips are connected to a controller configured to detect a short or a voltage change across the strips indicative of a leak in the plumbing line, and to issue an alarm or to shut-off one or more plumbing valves.

### CROSS REFERENCE TO RELATED APPLICATION

The present application claims the benefit of U.S. Provisional Application No. 63/229,147, filed Aug. 4, 2021, the disclosure of which is incorporated herein by reference in its entirety.

### FIELD OF THE INVENTION

The present invention is directed to plumbing systems, particularly an improved plumbing routing system and methods of installation and use of same.

### BACKGROUND OF THE INVENTION

Conventional methods of replacing existing plumbing lines in residential and commercial buildings are time-consuming and costly. As plumbing lines are often installed inside the walls of buildings, significant demolition is often required to access the plumbing lines, such as the removal of large sections of drywall. Even after the appropriate walls have been removed to access the existing plumbing lines, it can be cumbersome and awkward to remove the lines and install new pipes. The replacement of drywall and finishings, and re-painting incur further costs. Additionally, plumbing replacement procedures typically involve shutting off the water supply for extended periods of time, negatively affecting the comfort of residents and also revenue, in the case of businesses such as hotels.

It is also desirable to install and route new plumbing lines in such a manner so as to make maintenance and replacement easier and less costly, and to avoid the disadvantages of replacing existing plumbing systems.

An alternative process for replacing and/or installing plumbing lines involves installing plumbing lines along the outside of the interior walls of a building and constructing a “bulkhead” along the top of the walls to conceal the plumbing lines and other utilities therein. Such bulkheads typically comprise drywall attached to a box frame made of wood or metal, and are not designed to be easily opened or removed for access to the plumbing lines therein, for example for maintenance purposes.

Other systems comprise discrete retaining clips fixed to the outside surface of a wall, for example by screwing the clips into studs behind the wall or using drywall anchors, to retain plumbing lines. The clips can include a mechanism for securing elongate caps or covers thereto to hide the plumbing lines from sight. However, mounting the clips can be labour intensive, requiring installers to ensure that each clip is level with adjacent clips. Drywall anchors may need to be installed in the event the required spacing of the clips is smaller than the spacing of wall studs. Additionally, depending on the spacing of the clips, the covers may be secured only loosely to the wall, resulting in unsightly gaps between the covers and wall and the potential for the covers to be inadvertently removed from the clips, for example in the event of an impact against the cover. Such impact can also damage the clip since the forces are localized to each clip. While the clips can be mounted closer together, such closer spacing may require the use of drywall anchors, thereby increasing installation time.

Additionally, while it is often desirable for plumbing systems to incorporate leak detection mechanisms such as water sensors, currently water sensors are placed only at strategic locations near fixtures, such as adjacent to toilets or under kitchen sinks, dishwashers, laundry machines, and the like. Water sensors are not conventionally installed within the walls of a building to monitor for leaks along the plumbing lines due to the difficulty of accessing portions of the system located within walls, building framing, and the like.

There remains a need for a system and method for routing new or replacing plumbing lines that permits robust and efficient installation with minimal demolition, allows for future access of plumbing lines for maintenance and repair, and provides leak detection capability along a substantial portion of the system as opposed to only at strategic locations.

### SUMMARY OF THE INVENTION

The present invention relates to an improved plumbing routing system and methods of installation and use of same. A plumbing routing system is provided herein for routing plumbing lines such as water supply lines. The system comprises one or more tracks having one or more clip-retaining mechanisms for securing one or more plumbing-retaining members thereto. The system further comprises one or more covers configured to be removably secured to the tracks. In some embodiments, the system further comprises a leak detection system for detecting leaks. The leak detection system comprises at least one pair of strips of conductive material running lengthwise along each of the tracks, covers, or both. The strips of each track or cover is electrically connected to the strips of adjacent tracks or covers such that the entire system is electrically connected via the strips. The strips are connected to a controller configured to detect a short or other voltage change across the strips indicative of a leak. The controller is also configured to issue an alarm or automatically actuate shut-off valves of the plumbing system in response to a detected leak.

The plumbing routing system and leak detection system may be installed with greatly reduced demolition in relation to conventional systems and methods, and is capable of detecting leaks at any location along the plumbing lines as opposed to only at discrete locations such as near fixtures. The system may also be used to remediate existing plumbing systems by simply disconnecting the existing system from the water supply, installing the new routing system, running the new lines along the new routing system, and connecting the new lines to the water supply.

Broadly, in one aspect, the invention comprises a system for routing a plumbing line along a wall comprising:

one or more tracks comprising one or more clip-retaining mechanisms and being attachable to the wall;

one or more plumbing-retaining members configured to grip the plumbing line and to be removably anchored to the one or more clip-retaining mechanisms; and

one or more covers configured to be removably secured to the one or more tracks.

In some embodiments, the system further comprises a leak detection system comprising at least one pair of strips of conductive material on the one or more tracks, the one or more covers, or both, the strips being connected to a controller configured to detect a short or a voltage change across the strips indicative of a leak in the plumbing line, and to issue an alarm or to shut-off one or more plumbing valves.

In some embodiments, the track comprises a generally flat body having a front surface, a back surface, opposing first and second ends, and opposing first and second lengthwise sides, the one or more clip-retaining mechanisms being positioned on the front surface.

In some embodiments, the clip-retaining mechanism comprises one or more grooves extending from the first end to the second end of the track, the grooves being either integral with the body or defined by a plurality of rails. In some embodiments, the rails extend outwardly from the front surface of the body, each rail being spaced parallel and apart from adjacent rails and defining a pair of rail lips delimiting a slot for removably anchoring the plumbing-retaining member therein.

In some embodiments, the track comprises first and second track lips extending along the first and second lengthwise sides and defining cover-engaging shoulders for retaining the cover. In some embodiments, the cover comprises first and second cover lips corresponding to the first and second track lips, and defining track-engaging shoulders for removably securing to the track.

In some embodiments, the track further comprises a snap line defining a removable fin and positioned proximate and parallel to the first lengthwise side and extending from the first end to the second end of the track.

In some embodiments, the plumbing-retaining member comprises a clip having a gripping portion for receiving and gripping the plumbing line, and a mounting portion for removably anchoring to the clip-retaining mechanism.

In some embodiments, the cover comprises a body having a substantially C-shaped axial cross-section, the body comprising a top wall, a bottom wall, and internal top and bottom supporting braces connected to a front wall to define an opening for enclosing the plumbing line. In some embodiments, the front wall comprises a snap line defining a removable fin and extending the width of the front wall.

In some embodiments, the cover comprises a body having a substantially slide-shaped axial cross-section, the body comprising a back wall, a top wall, and a slide portion connected to the back wall by a supporting brace to define a cavity for enclosing the plumbing line.

In some embodiments, the system further comprises one or more corner covers for enclosing plumbing lines at one or more outer or inner corners where adjacent tracks meet. In some embodiments, the system further comprises one or more end caps configured for engaging with the tracks and the covers at terminal ends.

In another aspect, the invention comprises a method of routing a plumbing line along a wall comprising:

attaching one or more tracks comprising one or more clip-retaining mechanisms to the wall;

removably anchoring one or more plumbing-retaining members configured to grip the plumbing line to the one or more clip-retaining mechanisms;

placing the plumbing line within the plumbing-retaining members; and

removably securing one or more covers to the one or more tracks.

In yet another aspect, the invention comprises a method of detecting a leak in a plumbing line along a wall comprising:

attaching one or more tracks comprising at least one pair of strips of conductive material to the wall and one or more clip-retaining mechanisms;

removably anchoring one or more plumbing-retaining members configured to grip the plumbing line to the one or more clip-retaining mechanisms;

placing the plumbing line within the plumbing-retaining members; and

removably securing one or more covers comprising at least one pair of strips of conductive material to the one or more tracks; and

connecting the strips of the tracks and the covers to a controller configured to detect a short or a voltage change across the strips indicative of the leak, and to issue an alarm or to shut-off one or more plumbing valves.

Additional aspects and advantages of the present invention will be apparent in view of the description, which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1A is a perspective view of a track of an embodiment of the plumbing routing system. FIG. 1B is a side view of the track of FIG. 1A.

FIG. 2 shows perspective views of plumbing-retaining members in the form of various clips.

FIG. 3A is a perspective view of a first embodiment of a cover. FIG. 3B is a side view of the cover of FIG. 3A. FIG. 3C is a perspective view of a second embodiment of the cover of FIG. 3A including strips of conductive material.

FIG. 4A is a perspective view of a third embodiment of a cover. FIG. 4B is a side view of the cover of FIG. 4A.

FIG. 5A is a perspective view of a first embodiment of the plumbing routing system including the track of FIG. 1A-B, a pipe clip of FIG. 2 gripping the plumbing line, and cover of FIG. 3A-B or 3C, when assembled. FIG. 5B is a side cross-sectional view of the system of FIG. 5A.

FIG. 6A is a perspective view of a second embodiment of the plumbing routing system including the track of FIG. 1A-B, a crown clip of FIG. 2 gripping the plumbing line, and cover of FIG. 4A-B, when assembled. FIGS. 6B-C are side cross-sectional views of the system of FIG. 6A including one (FIG. 6B) and two (FIG. 6C) crown clips.

FIG. 7A is a perspective view of an outer corner cover. FIG. 7B is a perspective view of the outer corner cover of FIG. 7A installed on two lengths of track. FIG. 7C is a perspective view of the outer corner cover of FIG. 7B including two covers installed on the two lengths of track.

FIG. 8A is a perspective view of an inner corner cover being installed on two lengths of track. FIG. 8B is a perspective view of the inner corner cover of FIG. 8A including two covers being installed on the two lengths of track.

FIG. 9 is a perspective view of an end cap being installed over a terminal end of an embodiment of the plumbing routing system.

FIG. 10 is a perspective view of the cover of FIG. 3C coupled with a transition cover having electrical connector contacts.

FIG. 11 is a schematic diagram of an electrical circuit of a leak detection system.

FIG. 12 is a side cross-sectional view of components of the leak detection system of FIG. 11.

FIG. 13 is a view of components of a control box having the leak detection system of FIG. 11 and wireless water shutoff valves.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a,” “an,” and “the” include plural referents unless the context clearly dictates otherwise. The term “horizontal” means the orientation of a plane or line that is substantially parallel to the plane of the horizon. The term “vertical” means the orientation of a plane or line that is substantially at a right angle to the horizontal plane. The term “inward” refers to the direction towards a wall, and the term “outward” refers to the direction away from the wall.

The present invention relates to an improved plumbing routing system and methods of installation and use of same. The system is installed on the outer surface of walls of a building for which it is desired to install or replace plumbing lines. While the system is shown in the figures to be installed horizontally for ease of reference, it is to be understood that the system is configured to be installed either horizontally or vertically, allowing corresponding plumbing lines to be installed either horizontally or vertically. In some embodiments, the system may comprise a leak detection system configured to issue an alarm signal to report a leak and/or to close shutoff valves of the plumbing system to prevent further fluid flow through the plumbing lines.

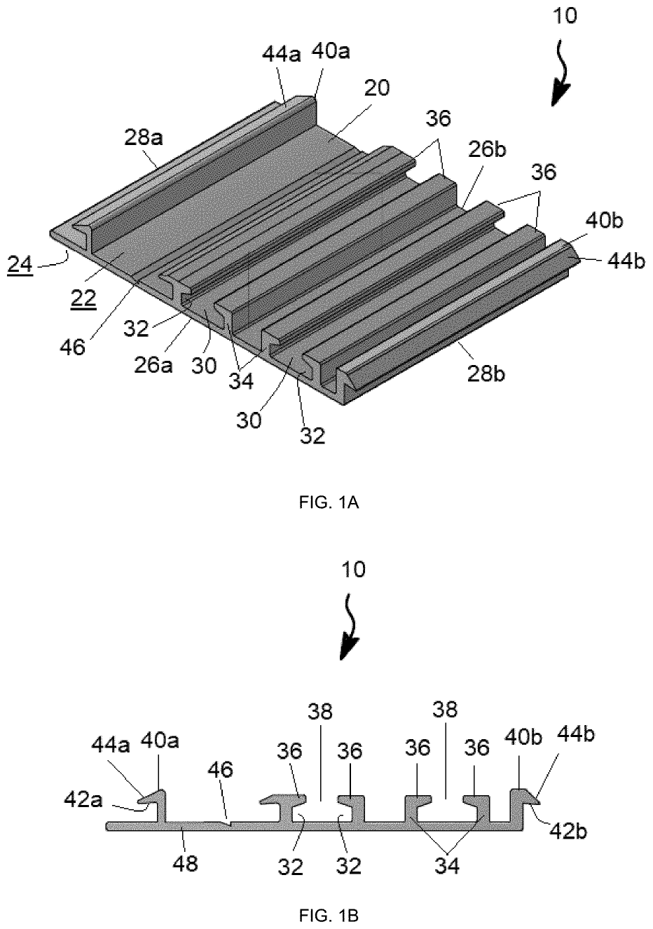

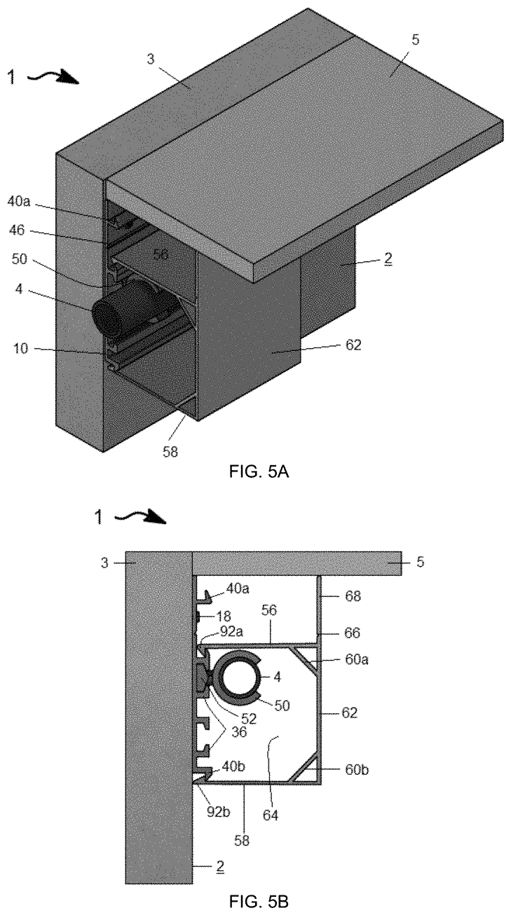

The invention will now be described having reference to the accompanying Figures. The system (1) is shown unassembled in FIGS. 1A-4B and 7A-10 to show all the components in greater detail, and installed and ready for use in FIGS. 5A-6C and 11-13. The system (1) generally comprises the following components: one or more lengths of track (10) which is securable to the outer surface (2) of a wall (3); a plurality of plumbing-retaining members (12) for gripping plumbing lines (4); and a cover (16) for enclosing both the track (10), plumbing-retaining members (12), and plumbing lines (4) therein.

As shown in FIGS. 1A-B and 5A-6C, one or more lengths of track (10) are securable to the outer surface (2) of a wall (3) using suitable attachment means (18) including, but not limited to, screws, nails, and the like. Each track (10) comprises a generally flat body (20) having a front surface (22), a back surface (24), opposing first and second ends (26a, 26b), and opposing first and second lengthwise sides (28a, 28b). In some embodiments, the body (20) has a substantially rectangular shape.

The track (10) further comprises a clip-retaining mechanism positioned on the front surface (22) of the body (20) to anchor the plumbing-retaining members (12) to the front surface (22) of the track (10). In some embodiments, the clip-retaining mechanism comprises one or more grooves (30) extending from the first end (26a) to the second end (26b) of the track (10), and defining a clip-anchoring channel (32). In some embodiments, the grooves (30) are formed in the body (20) itself. In some embodiments, the grooves (30) are formed by rails (34). In some embodiments, the rails (34) extend outwardly from the front surface (22) of the body (20). In some embodiments, the rails (34) extend perpendicularly from the front surface (22) of the body (20). The rails (34) are oriented to extend between the opposing first and second ends (26a, 26b) along the entire length of the first and second lengthwise sides (28a, 28b). Each rail (34) is spaced parallel and apart from adjacent rails (34) to form the grooves (30) therebetween for receiving the plumbing-retaining members (12). A pair of rail lips (36) delimit a slot (38) between them for anchoring the plumbing-retaining members (12) within the clip-anchoring channel (32).

The track (10) further comprises a cover-retaining mechanism for coupling a cover (16) to the track (10). In some embodiments, the first portion of the cover-retaining mechanism comprises first and second track lips (40a, 40b) extending lengthwise along the first and second lengthwise sides (28a, 28b) of the track (10). Each of the first and second track lips (40a, 40b) has inward or wall-facing sides (42a, 42b) forming cover-engaging shoulders (44a, 44b). In some embodiments, the first and second track lips (40a, 40b) may include beveled or angled outer edges to facilitate the installation of a cover (16) thereon.

In some embodiments, the track (10) comprises a snap line (46) in the form of a notch to define a removable fin (48). The snap line (46) is positioned proximate and parallel to the first lengthwise side (28a) and extends from the first end (26a) to the second end (26b) of the track (10). The snap line (46) allows the fin (48) to be bent and snapped off along the snap line (46), decreasing the height of the track (10) for use in limited space applications. In some embodiments, the track (10) may be formed of plastic using plastic extrusion or molding processes. In some embodiments, the track (10) may be formed of metal including, but not limited to, galvanized steel, using standard metal smithing processes.

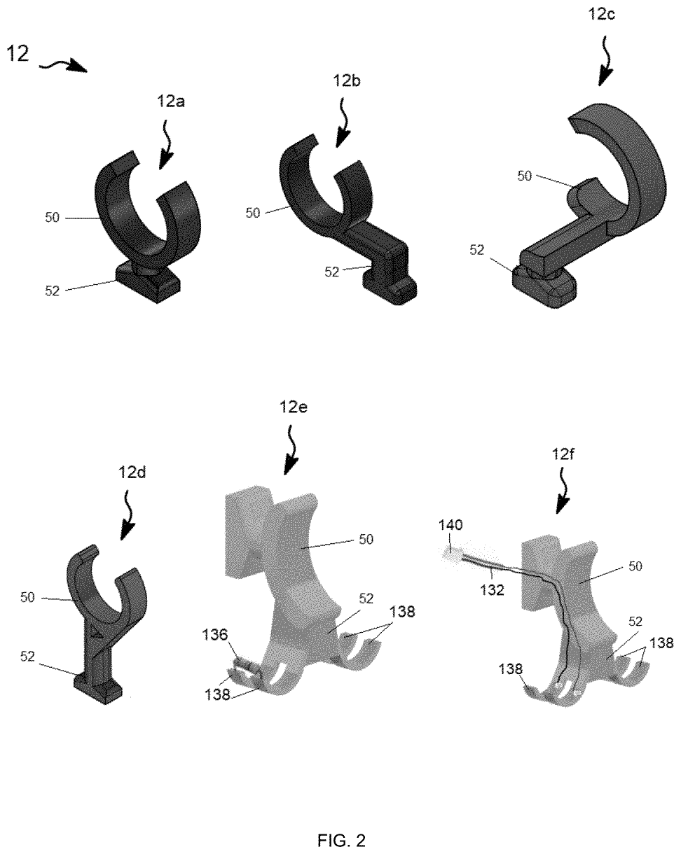

The plumbing-retaining members (12) can be off-the-shelf plumbing securing clips known in the art, or clips configured to couple with the grooves (30) of the tracks (10). As shown in FIG. 2, non-limiting examples of suitable clips include standard pipe holding clips such as, for example, pipe clips (12a) and crown clips (12b), or specialty clips such as, for example, swivel clips (12c), recirc clips (12d), trace clips (12e), and trace end clips (120. In some embodiments, the clips (12a-120 may have a size corresponding to the pipe size ranging from about ¾ inches to about ½ inch. In some embodiments, the clips (12a-120 may be formed of plastic using plastic extrusion or molding processes.

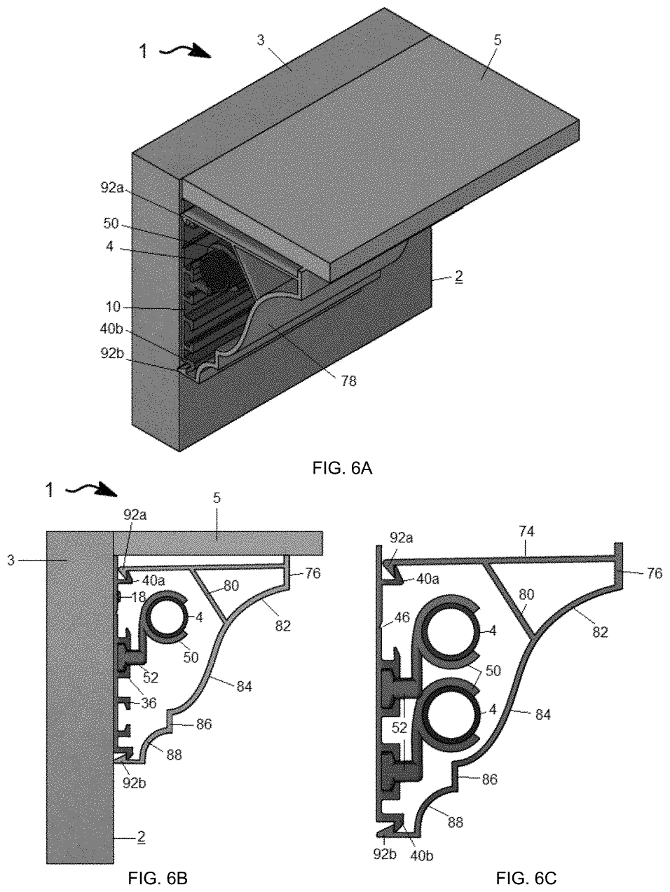

As shown in FIG. 2, each type of clip (12a-120 generally comprises a gripping portion (50) and a mounting portion (52). The gripping portion (50) is substantially C-shaped to snap-fit around a plumbing line (4). In some embodiments, the gripping portion (50) is made of a resilient material so as to be expandable around the plumbing line (4) and grip the plumbing line (4) snugly therein. In some embodiments, the gripping portion (50) may be in the form of any suitable strap or clamp known in the art. The mounting portion (52) is substantially T-shaped, having dimensions corresponding to the cross-sectional shape of the rail lips (36) and slot (38) when the clip (for example, 12a, 12b as shown in FIGS. 5A-6C) is in an anchored position where the clip (12a, 12b) is positioned perpendicular to the rails (34), but also allowing the clip (12a, 12b) to be inserted into, or removed from, within the clip-anchoring channel (32) when rotated to an installation position where the clip (12a, 12b) is positioned parallel to the rails (34). To secure a clip (12a, 12b) to the track (10), the mounting portion (52) of the clip (12a, 12b) is rotated to the installation position relative to the selected track groove (30) and inserted into the clip-anchoring channel (32). The clip (12a, 12b) is rotated to the anchored position, at which point the mounting portion (52) of the clip (12a, 12b) and the clip-anchoring channel (32) of the groove (30) cooperate to anchor the clip (12a, 12b) to the track (10).

In some embodiments, other clip-retaining mechanisms can be used to secure the plumbing-retaining members to the tracks. In some embodiments, the body (20) of the track (10) defines apertures for receiving corresponding pegs of the plumbing-retaining members therein.

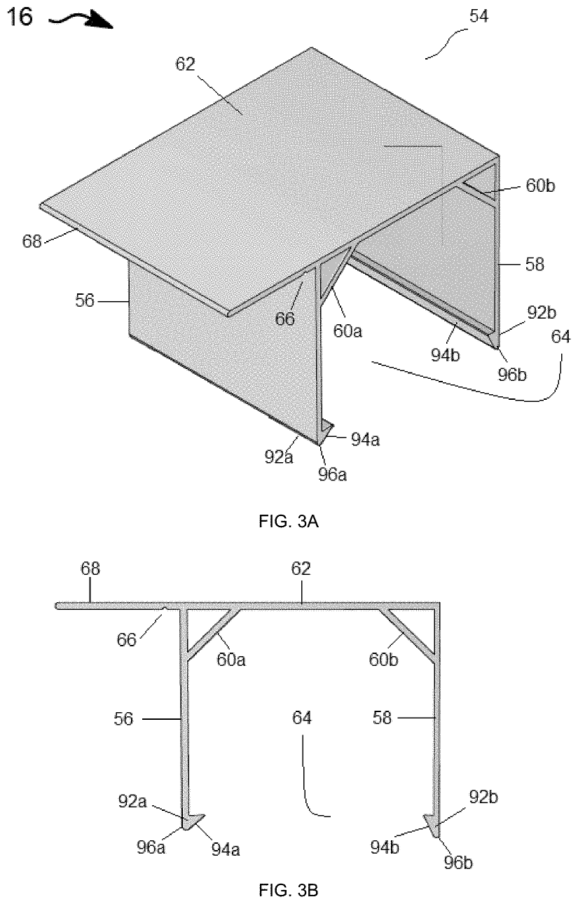

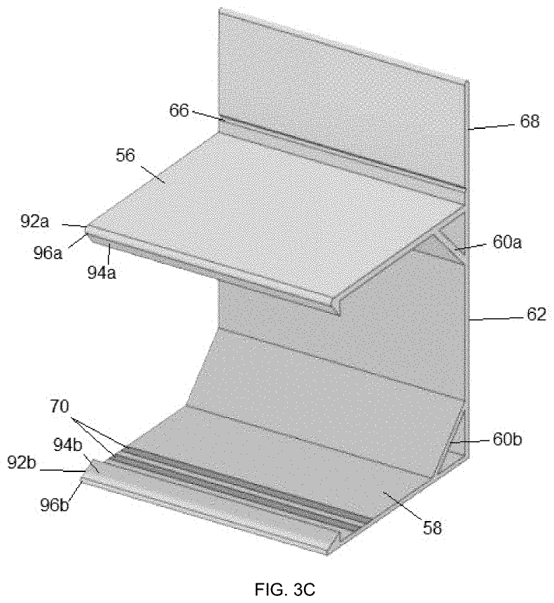

In some embodiments shown in FIGS. 3A-C, the cover (16) comprises a body (54) having a substantially C-shaped axial cross-section. The body (54) comprises a top wall (56), a bottom wall (58), and internal top and bottom supporting braces (60a, 60b) connected to a front wall (62) to define an opening (64) for accommodating and enclosing plumbing lines (4) secured to the track (10) when the cover (16) is coupled with the track (10). In some embodiments, the opening (64) also accommodates standard insulation to provide protection for the plumbing lines (4) from ambient temperature loss and sound attenuation. In some embodiments, the cover (16) is suitable for use with a standard pipe holding clip (12a) as shown in FIGS. 5A-B. The front wall (62) comprises a snap line (66) in the form of a notch to define a removable fin (68). The snap line (66) extends the width of the front wall (62) and allows the fin (68) to be bent and snapped off along the snap line (66), decreasing the height of the cover (16) for use in limited space applications. In some embodiments shown in FIG. 3C, the cover (16) comprises tracing wire (70) installed on the bottom wall (58). In some embodiments, the cover (16) is formed of plastic and/or metal.

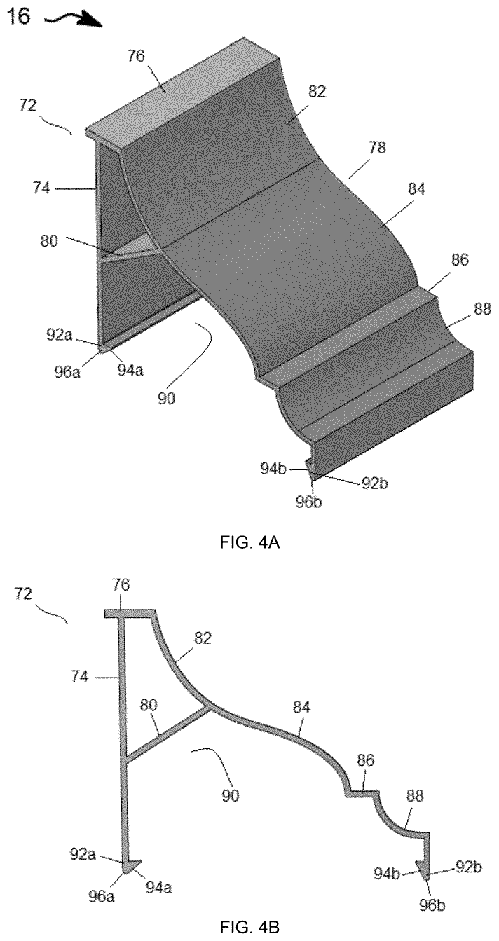

In some embodiments shown in FIGS. 4A-B, the cover (16) comprises a body (72) having a substantially slide-shaped axial cross-section. The body (72) comprises a back wall (74), a top wall (76), and a slide portion (78) connected to the back wall (74) by a supporting brace (80). The slide portion (78) comprises a first concave portion (82), a convex portion (84), a ledge portion (86), and a second concave portion (88). The back wall (74), supporting brace (80), and slide portion (78) define a cavity (90) for accommodating and enclosing plumbing lines (4) secured to the track (10) when the cover (16) is coupled with the track (10). In some embodiments, the cover (16) is suitable for use with a crown clip (12b) since the slide portion (78) provides a sufficiently sized cavity (90) to accommodate the crown clip (12b) (FIGS. 6A-C). In some embodiments shown in FIG. 6C where more than one crown clip (12b) is being used, the bottom crown clip (12b) is installed slightly off-set to the top crown clip (12b) to facilitate its installation. In some embodiments, the cavity (90) also accommodates standard insulation to provide protection for the plumbing lines (4) from ambient temperature loss and sound attenuation. In some embodiments, the cover (16) is formed of plastic and/or metal.

Each of the C-shaped and slide-shaped covers (16) further comprises a second portion of the cover-retaining mechanism for securing the cover (16) to the track (10). As shown in FIGS. 3A-B and 4A-B, the second portion of the cover-retaining mechanism comprises first and second cover lips (92a, 92b) corresponding to first and second track lips (40a, 40b). The first and second cover lips (92a, 92b) each have an outward-facing side (94a, 94b) forming track-engaging shoulders (96a, 96b). In some embodiments, the first and second cover lips (92a, 92b) have beveled or angled outer edges complementary to the beveled or angled outer edges of the first and second track lips (40a, 40b) in order to facilitate installation of the cover (16) to the track (10). In such embodiments, the cover (16) is aligned with the track (10) and pressed thereto. The cover (16) is made of a resilient material such that, when the cover (16) is pressed into the track (10), the first and second cover lips (92a, 92b) flex away from each other as they encounter the first and second track lips (40a, 40b). Once the cover lips (92a, 92b) pass the track lips (40a, 40b), the cover (16) returns to its original shape and the cover lips (92a, 92b) overlap the track lips (40a, 40b), thus retaining the cover (16) to the track (10). In some embodiments, the side walls of the cover (16) can have an overhang over the cover lips (92a, 92b) such that the overhang contacts the wall (3) when the cover (16) is secured to the track (10). Such overhang provides a visually appealing appearance when the cover (16) is secured to the track (10) by preventing apparent gaps between the cover (16) and the wall (3) and mitigating play between the cover (16) and the track (10).

In some embodiments, other cover-retaining mechanisms can be used to secure the covers (16) to the tracks (10). In some embodiments, the covers (16) can be secured to the tracks (10) with fasteners such as screws, or via an interference fit between the covers (16) and the tracks (10).

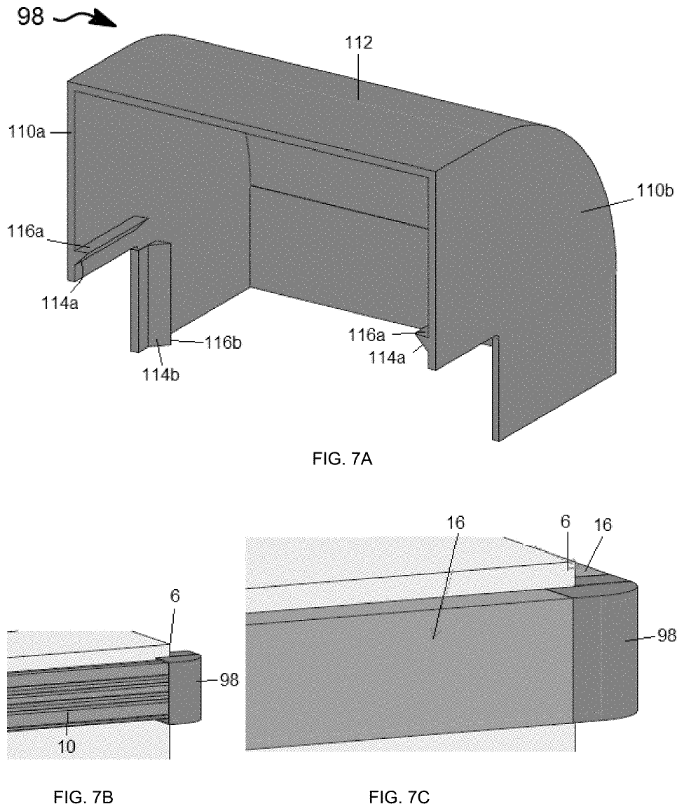

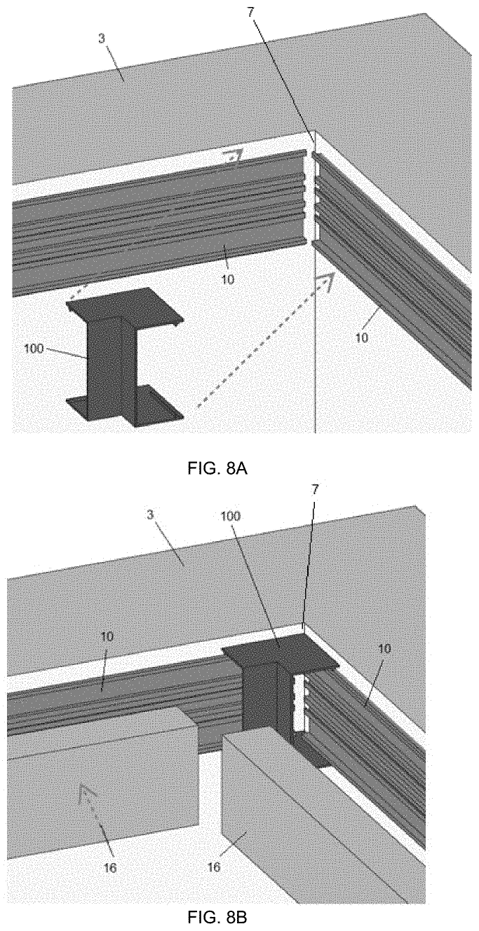

In some embodiments, outer and inner corner covers (98, 100) can be used to enclose plumbing lines (4) at outer (6) or inner corners (7) where two adjacent tracks (10) meet. As shown in FIGS. 7A-C, an outer corner cover (98) for connecting two adjacent lengths of track (10) meeting at an outer corner (6) comprises substantially L-shaped sidewalls (110a, 110b) connected by an outer wall (112). The sidewalls (110a, 110b) comprise a first opposing pair of outer corner lips (114a) located on a first limb (116a) of the sidewalls (110), and a second opposing pair of outer corner lips (114b) located on a second limb (116b) of the sidewalls (110). The first set of outer corner lips (114a) are configured to engage the track lips (40a, 40b) of a first track (10) on a first wall (3), and the second set of outer corner lips (114b) are configured to engage the track lips (40c, 40d) of a second track (10) on a second wall (3) adjacent the first wall (3). In this manner, the outer corner cover (98) can be removably secured to the first and second tracks (10a, 10b) to cover the plumbing lines (4) spanning therebetween. Similarly, as shown in FIGS. 8A-B, the inner corner cover (100) can be used to cover plumbing lines (4) spanning two adjacent lengths of track (10) meeting at an inner corner (7). In some embodiments, the outer or inner corner covers (98, 100) may be formed of plastic using plastic extrusion or molding processes.

As with the covers (16), other mechanisms can be used to retain the corner covers (98, 100) to the tracks (10), including via fasteners such as screws or an interference fit between the corner covers (98, 100) and the tracks (10).

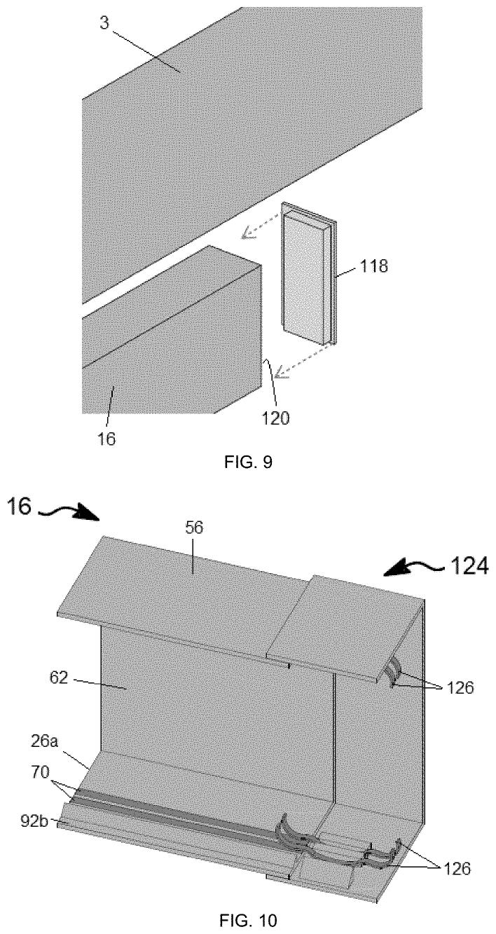

In some embodiments shown in FIG. 9, end caps (118) can be used to close off terminal ends (120) of the system (1). The end caps (118) are configured to engage with the coupled track (10) and cover (16) located at the terminal end (120). The end caps (118) provide an aesthetically pleasing finish to the system (1), while permitting easy access to the terminal ends (120) thereof.

In some embodiments, the system (1) further comprises a leak detection and mitigation system (122) for determining the presence of a leak and taking the appropriate steps in response such as automatically triggering an alarm and/or shutting off supply to the plumbing lines.

In some embodiments shown in FIGS. 3C and 10, each cover (16) comprises at least one pair of parallel leak detection strips (70) made of an electrically conductive material and running from the first end (26a) to the second end (26b) thereof. Transition covers (124) and the corner covers (98, 100) can each comprise at least one a pair of contact strips (126) configured to contact the detection strips (70) of adjacent covers (16) located on either side of the transition and corner covers (124, 98, 100), such that every cover (16), corner cover (98, 100), and transition cover (124) of the system (1) are electrically connected via their respective detection strips (70) and contact strips (126). In some embodiments, each of the covers (16), corner covers (98, 100), and transition covers (124) has a first pair of strips at a first side and a second pair of strips at a second opposite side.

A controller or central processing unit (“CPU”) (128) is electrically connected to the detection and/or contact strips (70, 126) and configured to detect a voltage change or short across the first and second strips of a pair of strips (70, 126). Such a voltage chance or short is indicative of a leak. For example, in normal operation, there should be no current flowing between the first and second strips of a pair of detection strips/transition strips (70, 126). In the event of a leak, when fluid electrically connects the strips (70, 126), the voltage thereacross should drop to zero or near zero to indicate a short.

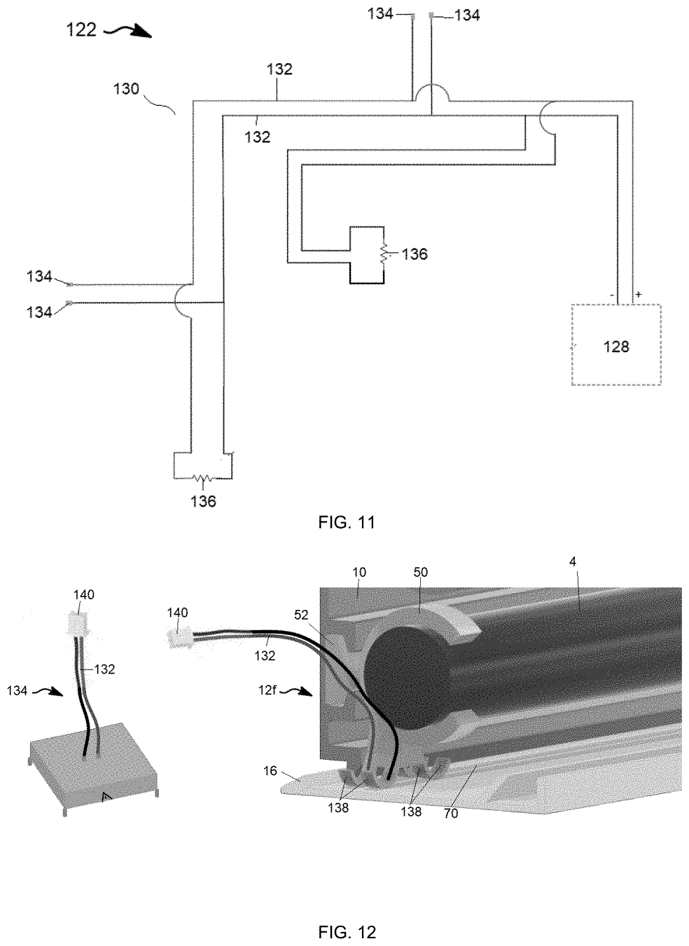

In some embodiments shown in FIG. 11, the electric circuit (130) includes the controller or CPU (128), tracing wires (132), trace puck electrodes (134), and resistors (136). As shown in FIGS. 2 and 12, trace clips (12e) and trace end clips (120 are positioned on the tracks (10) to grip the plumbing line (4), and also include conductive foil (138) on their legs for contact with the tracing wires (132). The trace clips (12e) include a connector (140) to attach to the trace puck electrodes (134) in the wall (3) or lead back to the controller (128). The trace end clips (120 include a resistor (136).

The controller (128) sends a low voltage current (for example, ranging between about 12V to about 16V) through the tracing wires (132), which returns after passing through the resistor(s) (136) at the end(s) of the electric circuit (130). A “calibrate” command is activated and the controller (128) records the “calibrated voltage” returned from the resistor(s) (136) compared to the supply voltage. A voltage drop is expected due to ohms law, with the amount of the voltage drop determined by the length of the tracing wire (132). During normal operation, the controller (128) records the returned voltage several times a second and compares it to the calibrated voltage. The voltage drop exceeding a predetermined percentage indicates a leak (i.e., water contacting the system (1)), and triggers valves (142) to shut off the water, preventing further damage. If the voltage reading is zero, the controller (128) determines that there is a break in the tracing wires (132), and activates the valves (142) to shut off the water supply to the plumbing lines (4).

In some embodiments, the controller (128) can issue an alarm signal, such as an audible and/or visual alarm, in response to the detection of a leak. The controller (128) may also be connected to a monitoring system located on-site or off-site, via wired or wireless networks, and indicate a leak to the monitoring system.

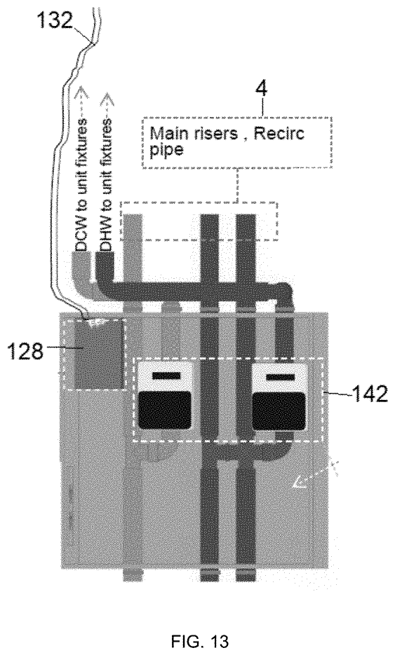

In some embodiments shown in FIG. 13, the controller (128) is connected to shutoff valves (142) of the plumbing system and to instruct the valves (142) to shut off water flow through the plumbing lines (4) in the event of a leak. The controller (128) is connected to the shutoff valves (142) via hardwire connections or via a wireless communications network.

In some embodiments, the detection strips (70) can be located on the tracks (10) as opposed to the covers (16). The detection strips (70) of adjacent tracks (10) can be electrically connected via transition tracks with contact strips similar in design to those of the transition covers (124), or the detection strips (70) of the tracks (10) can have an overhang on the first or second side thereof such that the detection strips (70) of a track (10) overlap and contact the detection strips (70) of a subsequent track (10).

In use, the tracks (10) of the system (1) are installed on the outer surface (2) of the interior walls (3) of a building according to the desired plumbing routing. In some embodiments, the track (10) is installed with the fin (48) in contact as closely as possible with the ceiling (5), even if uneven as with ceiling drywall mud. The tracks (10) are secured to the walls (3) using suitable attachment means (18) including, but not limited to, screws, fasteners, adhesives, and the like. In some embodiments, the attachment means (18) comprise screws driven into wall studs. One or more rows of screws may be used to secure the track (10) and provide additional stability. The plumbing-retaining members (12) are secured to the tracks (10) at the desired locations and intervals, and grip the plumbing lines (4) as shown in FIGS. 5A-B and 6A-C. The covers (16) are installed to enclose the tracks (10), plumbing-retaining members (12), and plumbing lines (4) with transition covers (124) used as appropriate to physically connect, and electrically connect in embodiments having a leak detection system (122), adjacent covers (16). Corner covers (98, 100) are installed at outer and inner corners (6, 7) as appropriate.

Existing plumbing systems can be retrofit or remediated using the system (1) with greatly reduced need to remove drywall and access the previous plumbing lines by simply disconnecting the existing plumbing lines from the water supply and connecting new plumbing lines to the supply. The system (1) can be installed as described above without demolition, and the interiors of walls need to be accessed only to pass the new plumbing lines between rooms/floors if the lines cannot be routed along the exterior of the walls.

The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the scope of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope of the present disclosure.

What is claimed is:

1. A system for routing a plumbing line along a wall comprising:
one or more tracks comprising one or more clip-retaining mechanisms and being attachable to the wall;
one or more plumbing-retaining members configured to grip the plumbing line and to be removably anchored to the one or more clip-retaining mechanisms; and
one or more covers configured to be removably secured to the one or more tracks.

2. The system of claim 1, further comprising a leak detection system comprising at least one pair of strips of conductive material on the one or more tracks, the one or more covers, or both, the strips being connected to a controller configured to detect a short or a voltage change across the strips indicative of a leak in the plumbing line, and to issue an alarm or to shut-off one or more plumbing valves.

3. The system of claim 1, wherein the track comprises a generally flat body having a front surface, a back surface, opposing first and second ends, and opposing first and second lengthwise sides, the one or more clip-retaining mechanisms being positioned on the front surface.

4. The system of claim 3, wherein the clip-retaining mechanism comprises one or more grooves extending from the first end to the second end of the track, the grooves being either integral with the body or defined by a plurality of rails.

5. The system of claim 4, wherein the rails extend outwardly from the front surface of the body, each rail being spaced parallel and apart from adjacent rails and defining a pair of rail lips delimiting a slot for removably anchoring the plumbing-retaining member therein.

6. The system of claim 3, wherein the track comprises first and second track lips extending along the first and second lengthwise sides and defining cover-engaging shoulders for retaining the cover.

7. The system of claim 6, wherein the cover comprises first and second cover lips corresponding to the first and second track lips, and defining track-engaging shoulders for removably securing to the track.

8. The system of claim 3, wherein the track further comprises a snap line defining a removable fin and positioned proximate and parallel to the first lengthwise side and extending from the first end to the second end of the track.

9. The system of claim 1, wherein the plumbing-retaining member comprises a clip having a gripping portion for receiving and gripping the plumbing line, and a mounting portion for removably anchoring to the clip-retaining mechanism.

10. The system of claim 1, wherein the cover comprises a body having a substantially C-shaped axial cross-section, the body comprising a top wall, a bottom wall, and internal top and bottom supporting braces connected to a front wall to define an opening for enclosing the plumbing line.

11. The system of claim 10, wherein the front wall comprises a snap line defining a removable fin and extending the width of the front wall.

12. The system of claim 1, wherein the cover comprises a body having a substantially slide-shaped axial cross-section, the body comprising a back wall, a top wall, and a slide portion connected to the back wall by a supporting brace to define a cavity for enclosing the plumbing line.

13. The system of claim 1, further comprising one or more corner covers for enclosing plumbing lines at one or more outer or inner corners where adjacent tracks meet.

14. The system of claim 1, further comprising one or more end caps configured for engaging with the tracks and the covers at terminal ends.

15. A method of routing a plumbing line along a wall comprising:
attaching one or more tracks comprising one or more clip-retaining mechanisms to the wall;
removably anchoring one or more plumbing-retaining members configured to grip the plumbing line to the one or more clip-retaining mechanisms;
placing the plumbing line within the plumbing-retaining members; and
removably securing one or more covers to the one or more tracks.

16. A method of detecting a leak in a plumbing line along a wall comprising:
attaching one or more tracks comprising at least one pair of strips of conductive material to the wall and one or more clip-retaining mechanisms;
removably anchoring one or more plumbing-retaining members configured to grip the plumbing line to the one or more clip-retaining mechanisms;
placing the plumbing line within the plumbing-retaining members; and
removably securing one or more covers comprising at least one pair of strips of conductive material to the one or more tracks; and
connecting the strips of the tracks and the covers to a controller configured to detect a short or a voltage change across the strips indicative of the leak, and to issue an alarm or to shut-off one or more plumbing valves.
